(19) United States
(12) Patent Application Publication
(10) Pub. No.: US 2018/0060553 A1
(43) Pub. Date: Mar. 1, 2018

(54) USING EDDY CURRENTS OF EXHALED BREATH FOR AUTHENTICATION

(71) Applicant: Lenovo (Singapore) Pte. Ltd., New Tech Park (SG)

(72) Inventor: Rod D. Waltermann, Rougemont, NC (US)

(21) Appl. No.: 15/249,830

(22) Filed: Aug. 29, 2016

(51) Int. Cl. G06F 21/32; H04L 29/06; G06K 9/46

(52) U.S. Cl. CPC G06F 21/32; H04N 5/232; G06K 9/4671; H04L 63/0861

(57) ABSTRACT

In one aspect, a device includes a processor and storage accessible to the processor. The storage bears instructions executable by the processor to compare an infrared (IR) image of a breath of a person and authenticating the person responsive to the image satisfying a match criteria with a prestored image.

### FIELD

The present application relates generally to using eddy currents of exhaled breath for authentication.

### BACKGROUND

As technology progresses, so do malicious hackers seeking to exploit technological vulnerabilities after getting past inadequate authentication safeguards. Furthermore, as understood herein, it is possible to produce images of human exhaled breath using infrared technology.

### SUMMARY

Accordingly, in one aspect a device includes a processor and storage accessible to the processor. The storage bears instructions executable by the processor to receive at least one image of eddy currents in exhaled breath, compare the at least one image to at least one template, and determine whether to authenticate a user responsive to the comparison.

In example embodiments, the image may be an infrared image. If desired, the instructions may be executable by the processor to, prior to comparing the image to the template, filter the image to output image portions only in the range of 4130 nm to 4427 nm.

In some implementations the instructions may be executable to, responsive to an eddy shape in the at least one image matching an eddy shape in the at least one template, return “authenticated”, whereas responsive to an eddy shape in the at least one image not matching an eddy shape in the at least one template, “not authenticated” may be returned. In other implementations, the instructions may be executable by the processor to, responsive to a breath period in the at least one image matching a breath period in the at least one template, return “authenticated”, and otherwise return “not authenticated”. In some embodiments both tests (breath period and eddy current shape) may be used and only one need be satisfied to return “authenticated” or both may be required to be satisfied to return “authenticated”.

In one specific non-limiting example, the template may include a nasal breath template representing a nasal breath and an oral breath template representing an oral breath, and the image may be compared to both templates. “Authenticated” may be returned responsive to the image matching either the nasal breath template or the oral breath template. Or, if desired “authenticated” may be returned responsive to the image matching both the nasal breath template and the oral breath template, but if only one of the templates matches, “not authenticated” may be returned in the this embodiment.

In another aspect, a computer readable storage medium (CRSM) that is not a transitory signal comprises instructions executable by a processor to compare a first image of a breath of a person with a second image, and responsive to determining that the first image satisfies a match condition with the second image, return a signal representing that the person is authenticated. However, responsive to determining that the first image does not satisfy a match condition with the second image, the instructions are executable to return a signal representing that the person is not authenticated.

In another aspect, a method includes accessing an infrared (IR) image of a breath of a person, and authenticating the person responsive to the IR image satisfying a match criteria with a prestored image. The method also includes not authenticating the person responsive to the IR image not satisfying a match criteria with a prestored image.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIG. 3 is a flow chart of example logic;

FIGS. 4-8 are illustrations schematically showing various breath eddies and periodicities; and

FIG. 9 is an example user interface (UI) that may be generated upon failure of authentication.

### DETAILED DESCRIPTION

As recognized herein, just as physiological features including airway features, lung capacity, diaphragm strength, etc. vary from person to person, so too do the eddy currents produced by exhaled breath, which are affected by physiological features that can change from person to person. As also recognized herein, these eddy currents that vary from person to person can be used for authentication.

Accordingly, the present disclosure relates to improving the security of individual computer systems by authenticating computer users at least in part using images of their exhaled breath. Such authentication is non-invasive and may be continuously employed, and may be less vulnerable to spoofing than authentication techniques such as face recognition.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

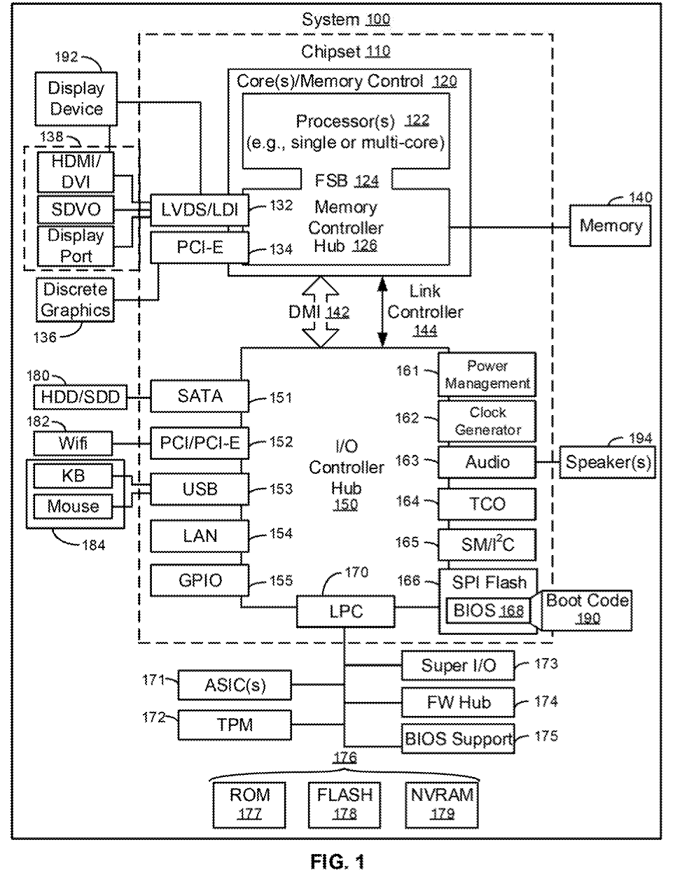

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB) and mice, microphones and various other devices (e.g., cameras including both visible spectrum cameras an infrared cameras such as forward looking infrared (FLIR) cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera such as mentioned above for the input device 184 that gathers one or more visible and/or IR images and provides input related thereto to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video. Still further, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

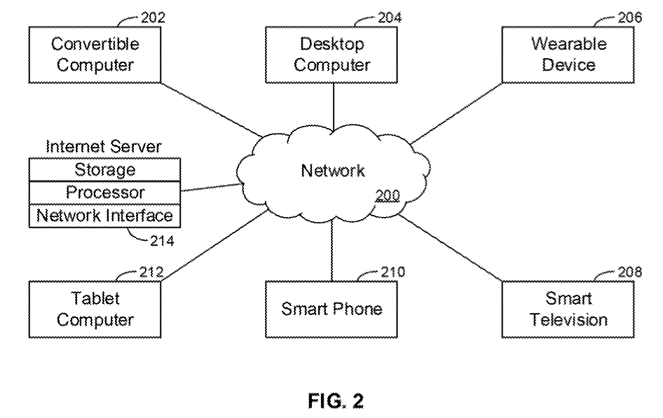

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

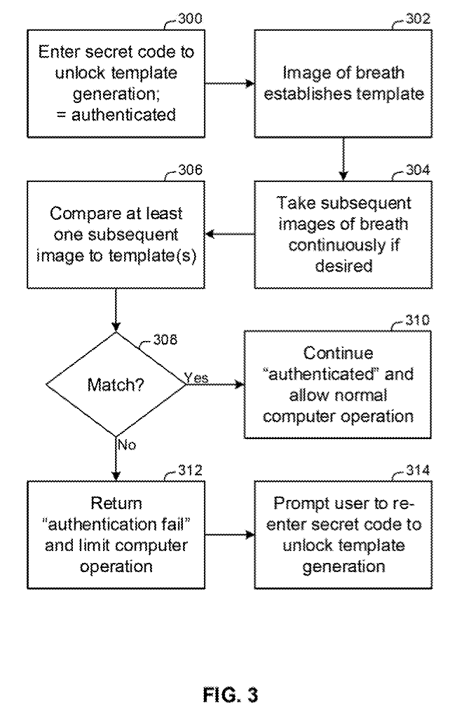

Referring to FIG. 3, logic is illustrated that may be performed by any of the devices discussed herein using its own IR camera and processor or the IR camera and/or processor of another device to authenticate a computer user, and to keep authenticating the computer user on a continuous or periodic basis at predetermined intervals if desired.

Commencing at block 300, a secret may be required to be entered to unlock the template generation mode. Entry of the code may result in the current user being authenticated. Typically, the code may be at the administrator level or other secrecy-maintaining level so that only authorized users likely will be able to obtain the code to generate a template.

Moving to block 302, one or more images of the person's breath are obtained to establish templates for subsequent use as described below. These images may be obtained using the above-described FLIR technology and camera 184. The template images are obtained for the type of parameter subsequently taken for comparison. For example, when the below-described real time image taken for comparison with the template is to be of a nasal exhale, then at least one of the templates will be of a nasal exhale eddy current. Likewise, when oral exhales are used, a template of an oral exhale is obtained at block 302, and when the periodicity of breath is used, multiple template images are obtained at block 302 to establish a baseline breathing periodicity for the person. Note that the templates may be stored in a library of templates of multiple authorized users.

Subsequent to establishing the baseline templates, the user of the computer may thereafter be monitored, essentially continuously if desired, by the FLIR camera or other imaging device taking subsequent test images of the user's breath at block 304. For example, a test image may be obtained every second, to ensure an authenticated user is operating the computer. Or, at subsequent login a test image may be generated.

When a test image is obtained, the logic can move from block 304 to block 306 to compare at least one test image with the templates obtained at block 302. In one example, the test image first is passed through a narrow band-pass filter so that only IR signals in the CO₂ absorption band (4130 nm-4427 nm) remain. The same filtering may be implemented on the template images obtained at block 302.

In one example, the test image(s) is compared to the template(s) corresponding to the user name at log in, and to no other templates in the library. In other embodiments the test image(s) may be compared to all of the templates in the library such that any previously authorized user will be authenticated.

It is determined, e.g., using image recognition for pattern matching, whether the test image(s) obtained at block 304 match a template obtained at block 302 and/or otherwise a template residing in the template library. For “match” to be returned, the test image may typically match the template within the tolerance demanded by the pattern matching recognition being employed.

Responsive to a match being found at diamond 308, the logic moves to block 310 to return a signal representing that the user is authenticated, equivalently, remains authenticated. Authentication enables normal computer operation for the user given the user's other security credentials and levels of access.

On the other hand, responsive to a match not being found at diamond 308, the logic moves to block 312 to return a signal representing that the user is not authenticated, equivalently, that authentication has failed. Failure of authentication limits computer operation and may lock the user out entirely from proceeding further to operate the computer. If desired, the logic may then move to block 314 to prompt the user to re-enter the secret code, assuming the user can access it or has access to it, and re-enter the code to unlock the template generation steps at block 302. An example user interface (UI) to this end is described further below.

Present principles understand that statistical analyses may be used to compensate for basic changes to the user from when the baseline template images are obtained, such as having a cold/allergies, or growing facial hair. Additionally, if the baseline templates were obtained while the user was at rest, and the user subsequently returns to the computer to operate it after having just exercised, the user's breathing pattern will be higher than that of the template images. Other subtle differences such as a deviated septum may create unique nasal exhale swirling due to differences in the left and right cavity flow restrictions.

In any case, the step of block 314 may be used in lieu of statistical analyses to account for any changes to an authorized user that may cause a test image of the authorized user not to match the authorized user's prior baseline template. If the user is an authorized user and experiences an authentication failure at block 312, such an authorized user presumably will be able to access the secret code and re-enter the template generation at blocks 300 and 302, whereas an unauthorized user failing authentication presumably will not be able to access the secret code to generate a “spoof” template.

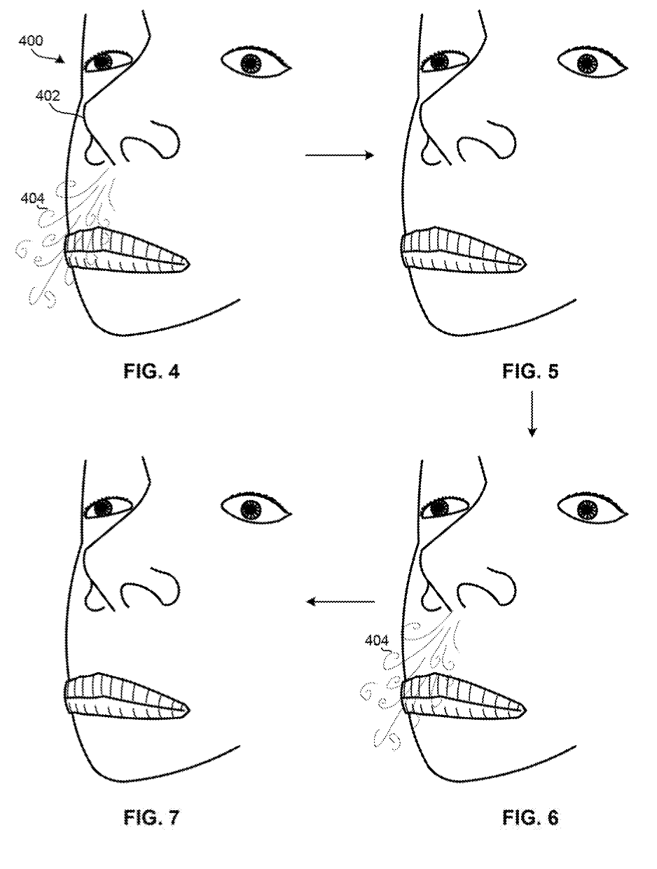

Refer now to FIGS. 4-7, showing an example user 400 exhaling, from his nose 402, a nasal breath to produce an eddy current 404 in the air, which owing to body heat warming the exhaled air may be imaged using, e.g., FLIR. From FIG. 4 the user inhales so no exhaled eddy current is shown in FIG. 5. The user subsequently exhales again as shown in FIG. 6 to produce the eddy current 404 once again, and inhales again as shown in FIG. 7 so no exhaled eddy current is produced. Both the precise size and shape of the eddy current 404 (more generally, size, shape, and relative direction of air flow or disturbances caused by the person's breathing) may be recorded, either as a baseline template at block 302 in FIG. 3 or as a subsequent test image, as well as the time between successive eddy current images, to be used to indicate breathing periodicity. Note that while exhaled eddy currents are used, air disturbances caused by inhaling alternatively may be used although such currents may be more difficult to discriminate from background.

In addition to or in lieu of using the eddy currents created by nasal exhalations, FIG. 8 shows that the eddy currents 802 caused by oral exhalation through the user's mouth 800 may be used. Such oral eddy currents typically are larger and thus more robust for analytical purposes than nasal eddy currents.

Thus, it may now be appreciated that the logic of FIG. 3 may be employed to, responsive to an eddy shape in a test image matching an eddy shape in a template, return “authenticated”, and otherwise return “not authenticated”. In addition or alternatively, the logic of FIG. 3 may be employed to, responsive to a breath period in a test image matching a breath period in a template, return “authenticated”, and otherwise return “not authenticated”. It may be further appreciated that the template can include one or more nasal breath templates and one or more oral breath templates, with both templates being compared to respective test images and with “authenticated” being returned responsive to a test image matching either the nasal breath template or the oral breath template. Or, “authenticated” may be returned only if test images match both nasal and oral templates.

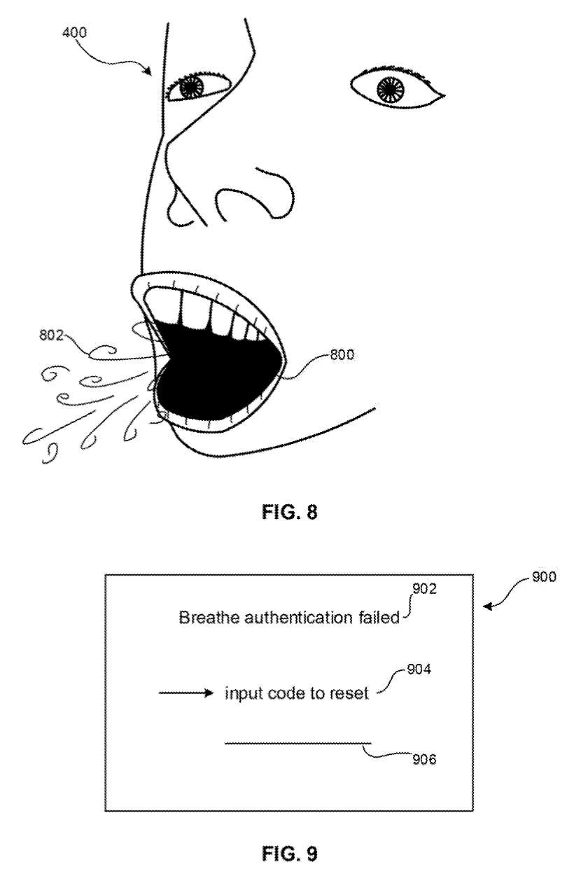

FIG. 9 shows an example UI 900 that may be presented on any of the displays herein responsive to the logic at block 314 of FIG. 3. A message 902 may be presented indicating that breath authentication has failed. A prompt 904 may be presented enter the secret code into a field 906 to permit re-entry into the template generation phase at block 302 of FIG. 3.

Additionally, in some embodiments a UI may be presented on a display of a device undertaking present principles for configuring settings of the device. For example, such a UI may include an option that is selectable to enable eddy current authentication as disclosed herein, and deselectable to not use eddy current authentication.

By itself or when combined with the rhythm of breathing, the eddy current imaging described herein creates a unique pattern that is detectable to cameras tuned for infrared. By applying a continuous, non-invasive monitoring technique, present disclosure allows for not only physical presence, but can detect if a different person is operating the device. This added layer of authentication can be used to ensure that not only is the user in front of the system, but based on the air current swirls, and breathing pattern, it is an authenticated user.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor;
a camera accessible to the processor; and
storage accessible to the processor and bearing instructions executable by the processor to:
receive at least one image from the camera of eddy currents in exhaled breath;
compare the at least one image to at least one template; and
responsive to the comparison, determine whether to authenticate a user.

2. The device of claim 1, wherein the at least one image is an infrared image.

3. The device of claim 1, wherein the instructions are executable by the processor to:
prior to the comparison, filter the at least one image to output image portions only in the range of 4130 nm to 4427 nm.

4. The device of claim 1, wherein the instructions are executable by the processor to:
responsive to an eddy shape in the at least one image matching an eddy shape in the at least one template, authenticate the user; and
responsive to an eddy shape in the at least one image not matching an eddy shape in the at least one template, decline to authenticate the user.

5. The device of claim 1, wherein the instructions are executable by the processor to:
responsive to a breath period in the at least one image matching a breath period in the at least one template, authenticate the user; and
responsive to a breath period in the at least one image not matching a breath period in the at least one template, decline to authenticate the user.

6. The device of claim 4, wherein the instructions are executable by the processor to:
responsive to a breath period in the at least one image matching a breath period in the at least one template, authenticate the user; and
responsive to a breath period in the at least one image not matching a breath period in the at least one template, decline to authenticate the user.

7. The device of claim 1, wherein the at least one template comprises at least one nasal breath template representing a nasal breath and at least one oral breath template representing an oral breath, wherein the comparison comprises comparing the at least one image to both the at least one nasal breath template and the at least one oral breath template, and wherein the instructions are executable to authenticate the user responsive to the at least one image matching one of the at least one nasal breath template and the at least one oral breath template.

8. The device of claim 1, wherein the at least one template comprises at least one nasal breath template representing a nasal breath and at least one oral breath template representing an oral breath, wherein the comparison comprises comparing the at least one image to both the at least one nasal breath template and the at least one oral breath template, wherein the instructions are executable to authenticate the user responsive to the at least one image matching both the at least one nasal breath template and the at least one oral breath template, and wherein the instructions are executable to decline to authenticate the user responsive to the at least one image not matching both the at least one nasal breath template and the at least one oral breath template.

9. A computer readable storage medium (CRSM) that is not a transitory signal, the computer readable storage medium comprising instructions executable by a processor to:
compare a first image of a breath of a person with a second image;
responsive to determining that the first image satisfies a match condition with the second image, return a signal representing that the person is authenticated; and
responsive to determining that the first image does not satisfy a match condition with the second image, return a signal representing that the person is not authenticated.

10. The CRSM of claim 9, wherein the first image is an infrared (IR) image.

11. The CRSM of claim 9, comprising the at least one processor.

12. The CRSM of claim 9, wherein the second image is at least one template, and wherein the instructions are executable by the processor to:
prior to the comparison, filter the first image to output image portions only in the range of 4130 nm to 4427 nm.

13. The CRSM of claim 9, wherein the instructions are executable by the processor to:
responsive to an eddy shape in the first image satisfying a match condition in the second image, return a signal representing that the person is authenticated; and
responsive to an eddy shape in the first image not satisfying a match condition in the second image, return a signal representing that the person is not authenticated.

14. The CRSM of claim 9, wherein the instructions are executable by the processor to:
responsive to a breath period in the first image satisfying a match condition in the second image, return a signal representing that the person is authenticated; and
responsive to a breath period in the first image not satisfying a match condition in the second image, return a signal representing that the person is not authenticated.

15. The device of claim 13, wherein the instructions are executable by the processor to:
responsive to a breath period in the first image satisfying a match condition in the second image, return a signal representing that the person is authenticated; and
responsive to a breath period in the first image not satisfying a match condition in the second image, return a signal representing that the person is not authenticated.

16. The CRSM of claim 9, wherein the second image comprises at least one nasal breath template representing a nasal breath and at least one oral breath template representing an oral breath, wherein the comparison comprises comparing the first image to both the at least one nasal breath template and the at least one oral breath template, and wherein the instructions are executable to return a signal representing that the person is authenticated responsive to the first image satisfying a match condition with one of the at least one nasal breath template and the at least one oral breath template.

17. A method, comprising:
accessing an infrared (IR) image of a breath of a person;
authenticating the person responsive to the IR image satisfying a match criteria with a prestored image; and
not authenticating the person responsive to the IR image not satisfying a match criteria with a prestored image.

18. The method of claim 17, comprising:
responsive to an eddy shape in the first image satisfying a match condition in the second image, returning a signal representing that the person is authenticated; and
responsive to an eddy shape in the first image not satisfying a match condition in the second image, returning a signal representing that the person is not authenticated.

19. The method of claim 17, comprising:
responsive to a breath period in the first image satisfying a match condition in the second image, returning a signal representing that the person is authenticated; and
responsive to a breath period in the first image not satisfying a match condition in the second image, returning a signal representing that the person is not authenticated.

20. The method of claim 17, wherein the second image comprises at least one nasal breath template representing a nasal breath and at least one oral breath template representing an oral breath, and wherein the method comprises:
comparing the first image to both the at least one nasal breath template and the at least one oral breath template, and returning a signal representing that the person is authenticated responsive to a result of the comparing.

21. The method of claim 17, comprising:
responsive to accessing the IR image, filtering the IR image to output IR image portions only in the range of 4130 nm to 4427 nm; and
using the IR image portions for whether the IR image satisfies the match criteria.
